(19) United States
(12) Patent Application Publication
(10) Pub. No.: US 2024/0318412 A1
(43) Pub. Date: Sep. 26, 2024

(54) Rainwater Harvesting Prefilter

(71) Applicant: Sycamore Technical Services LLC, Knoxville, TN (US)

(72) Inventors: Joe W. Anderson, Knoxville, TN (US); Ronald W. Anderson, Knoxville, TN (US); James C. Powers, Oak Ridge, TN (US); Denis Rochat, Knoxville, TN (US)

(73) Assignee: Sycamore Technical Services LLC, Knoxville, TN (US)

(21) Appl. No.: 18/124,900

(22) Filed: Mar. 22, 2023

(51) Int. Cl. E03B 3/02; B01D 29/27

(52) U.S. Cl. CPC E03B 3/02; B01D 29/27

(57) ABSTRACT

A rainwater harvesting prefilter having a filter drum. The filter drum includes a fluid inlet configured to be fluidly connected to a fluid entrance pipe of a rainwater collection system and a fluid outlet configured to be fluidly connected to a cistern tank. A filter assembly is disposed in the filter drum. The filter assembly includes a filter support plate (with supporting components as needed) suspended in the filter drum such that the filter support plate spans across and substantially covers a width of the filter drum to separate the filter drum into an upper chamber having the fluid inlet and a lower chamber having the fluid outlet. A plurality of spaced-apart apertures are disposed in the filter support plate. A plurality of filter socks are positionable in the plurality of spaced apart apertures such that filter socks extend downward from the filter support plate into the lower chamber.

### FIELD

This disclosure relates to the field of rainwater harvesting systems. More particularly, this disclosure relates to a rainwater harvesting prefilter for a cistern tank.

### BACKGROUND

Rainwater harvesting involves collecting run-off rainwater from a structure (e.g., roof) or other surface for storage and then repurposed for later use. Collection systems often involve using various diverters and pipes to direct the rainwater to a large cistern tank. During collection, the rainwater is filtered to prevent leaf and debris build-up. However, current filtering systems suffer from many deficiencies. For example, particularly during high flow periods, the filters will become overrun or otherwise cannot successfully capture all of the rainwater that is attempted to be diverted to the cistern tank. Additionally, many of the filtering systems on the market are elaborate systems intended for industrial applications and/or are otherwise too expensive for average household purposes.

What is needed therefore is a rainwater harvesting prefilter system that solves the above deficiencies.

### SUMMARY

The above and other needs are met by a rainwater harvesting prefilter. The prefilter includes a filter drum and a filter assembly disposed in the filter drum. The filter drum includes a fluid inlet configured to be fluidly connected to a fluid entrance pipe of a rainwater collection system and a fluid outlet configured to be fluidly connected to a cistern tank. The filter assembly includes a filter support plate suspended in the filter drum such that the filter support plate spans across and substantially covers a width of the filter drum to separate the filter drum into an upper chamber having the fluid inlet and a lower chamber having the fluid outlet, a plurality of spaced-apart apertures disposed in the filter support plate, and a plurality of filter socks for filtering rainwater as it flows through the fluid inlet to the fluid outlet. Each of the plurality of filter socks are positionable in one of the plurality of spaced apart apertures such that filter sock extends downward from the filter support plate into the lower chamber.

According to certain embodiments, the filter support plate is sealed to an interior sidewall of the filter drum. In some embodiments, the filter drum includes an interior sidewall having an inward protruding portion and the filter support plate is sealed to the inward protruding portion.

According to certain embodiments, the plurality of filter socks are configured to be removably inserted into the spaced-apart apertures of the filter support plate.

According to certain embodiments, the plurality of filter socks are configured to retain particulates that are about 200 microns or larger.

According to certain embodiments, the filter assembly further includes a hold down plate configured to be positioned over the filter support plate to assist in maintaining the plurality of filter socks in the plurality of spaced apart apertures. In some embodiments, the hold down plate includes a plurality of spaced-apart apertures positioned and configured to be vertically aligned with the plurality of spaced-apart apertures of the filter support plate when the hold down plate is positioned over the filter support plate. According to some embodiments, each of the plurality of filter socks include a lip extending radially from a top end of the filter sock such that the lip is disposed between the hold down plate and the filter support plate when the hold down plate is positioned over the filter support plate. In some embodiments, the hold down plate includes a plurality of grooves for receiving fasteners, the grooves including a narrow portion for removably fastening the hold down plate to the filter support plate when the fasteners are tightened and a wider portion for removing the hold down plate from the filter support plate when the fasteners are loosened.

According to certain embodiments, the fluid outlet includes a plurality of outlet nozzles.

According to some embodiments, the system further includes a calming inlet assembly having a plurality of inlet nozzles each fluidly connected to one of the plurality of outlet nozzles of the filter drum.

According to certain embodiments, the filter assembly further includes one or more vertical supports extending from a bottom plate positioned adjacent a bottom of the filter drum to the filter support plate.

According to another embodiment of the disclosure, a method of forming a rainwater harvesting prefilter includes selecting a prefilter drum having a volume that ranges from about 14 gallons to about 165 gallons; forming a fluid inlet and a fluid outlet in the prefilter drum; providing a filter support plate having a plurality of spaced-apart apertures; sealing the filter support plate to an interior sidewall of the filter drum such that the filter support plate spans across and substantially covers a width of the filter drum to separate the filter drum into an upper chamber having the fluid inlet and a lower chamber having the fluid outlet; positioning filter socks in each of the plurality of spaced apart-apertures such that the filter socks extend downward from the filter support plate into the lower chamber, the filter socks for filtering rainwater as it flows through the fluid inlet to the fluid outlet.

According to certain embodiments, the interior sidewall of the filter drum includes an inward protruding portion and the filter support plate is sealed to the inward protruding portion.

According to certain embodiments, the filter socks are configured to retain particulates that are about 200 microns or larger.

According to certain embodiments, the method further includes positioning a hold down plate over the filter support plate to assist in maintaining the filter socks in the plurality of spaced apart apertures. In some embodiments, the hold down plate includes a plurality of spaced-apart apertures positioned and configured to be vertically aligned with the plurality of spaced-apart apertures of the filter support plate when the hold down plate is positioned over the filter support plate. According to some embodiments, the hold down plate includes a plurality of grooves for receiving fasteners, the grooves including a narrow portion for removably fastening the hold down plate to the filter support plate when the fasteners are tightened and a wider portion for removing the hold down plate from the filter support plate when the fasteners are loosened.

According to certain embodiments, the method further includes securing a distal end of one or more vertical supports to a bottom plate, positioning the bottom pate with one or more vertical supports adjacent a bottom of the filter drum, and securing a proximal end of the one or more vertical supports to the filter support plate to form a support structure for the filter support plate.

### BRIEF DESCRIPTION OF THE DRAWINGS

Other embodiments of the disclosure will become apparent by reference to the detailed description in conjunction with the figures, wherein elements are not necessarily to scale so as to more clearly show the details, wherein like reference numbers indicate like elements throughout the several views, and wherein:

FIG. 1 depicts a prefilter fluidly connected to a vertically oriented fluid entrance pipe according to one embodiment of the disclosure.

FIG. 2 depicts a prefilter fluidly connected to a horizontally oriented fluid entrance pipe according to another embodiment of the disclosure.

FIG. 3 depicts a partial cross-sectional view of a prefilter according to one embodiment of the disclosure.

FIG. 4 depicts an overhead perspective view of a hold down plate of a filter assembly removably connected to a support plate according to one embodiment of the disclosure.

FIG. 5 depicts a partial cross-sectional view of a prefilter according to another embodiment of the disclosure.

FIG. 6 depicts an overhead view of a support plate of a filter assembly according to one embodiment of the disclosure.

FIG. 7 depicts a partial cross-sectional view of a prefilter intended to be installed inside a cistern tank according to one embodiment of the disclosure.

FIG. 8 depicts an overhead view of a top plate of a calming inlet assembly according to one embodiment of the disclosure.

### DETAILED DESCRIPTION

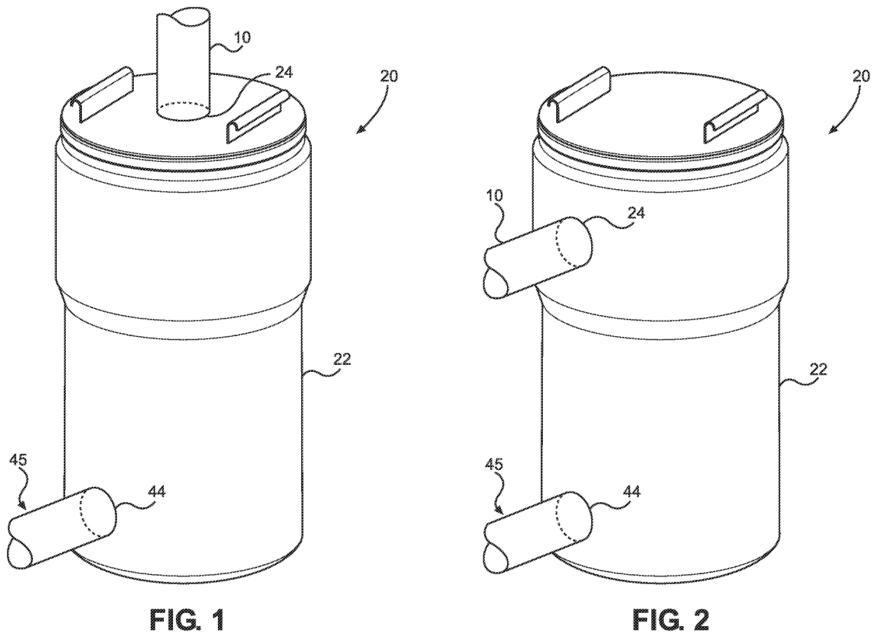

Referring to FIGS. 1-2, the present disclosure is directed to a rainwater harvesting prefilter 20 that is intended to be installed inside or outside a cistern tank (not shown). The cistern tank may be underground or above ground. Captured rainwater is intended to flow through the prefilter 20 to be discharged into the cistern tank for storage and subsequent use, further filtering, and/or delivery by the cistern tank's regular distribution system. The prefilter 20 includes a filter drum 22 having a fluid inlet 24 that is dimensioned and configured to be fluidly connected to a fluid entrance pipe 10 of the rainwater harvesting system. As shown in FIG. 1, the fluid inlet 24 may be disposed in the top surface or lid of the filter drum 22 for receiving water through a vertically oriented entrance pipe 10 or, as shown in FIG. 2, in a sidewall of the filter drum 22 for receiving water through a horizontally oriented entrance pipe 10. The filter drum 22 further includes one or more fluid outlets 44. Similar to the fluid inlet 24, the one or more fluid outlets 44 may be disposed in the side of the filter drum 22 (such as when the fluid outlet 44 is intended to be fluidly connected to a horizontal exit pipe 45 that leads to the cistern tank) or to the bottom of the filter drum 22 (such as when the fluid outlet 44 is intended to be fluidly connected to a vertical pipe that leads to or is otherwise disposed inside the cistern tank). For purposes of the present disclosure, two components that are referred to as “fluidly connected” may be fluidly connected directly to each other or fluidly connected through intervening components. For example, the fluid outlet 44 referred to as being fluidly connected to a cistern tank may include pipes and other fluidly connected structures disposed between the fluid outlet and the cistern tank.

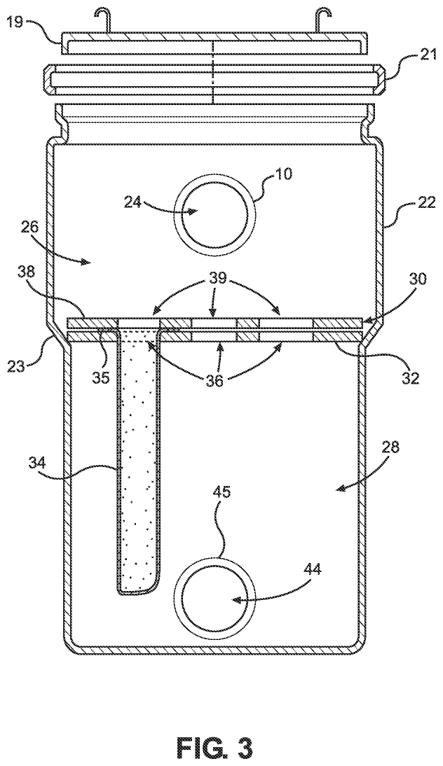

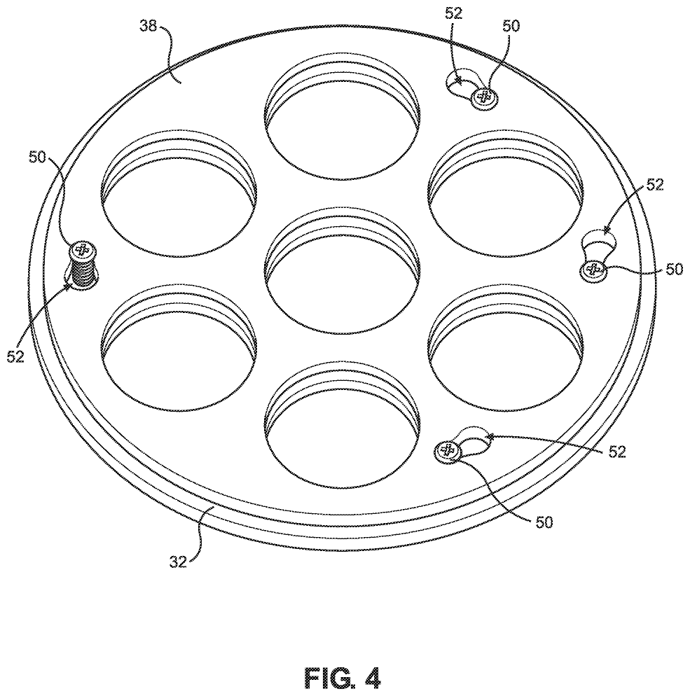

Referring to FIG. 3, the interior of an exemplary embodiment of the prefilter drum 22 includes a filter assembly 30 in which all collected rainwater received through the fluid inlet 24 from the fluid entrance pipe 10 must pass through before exiting the prefilter 20 through the fluid outlet 44 for collection in the cistern tank. The filter assembly 30 includes a filter element support plate 32 for supporting a plurality of filter elements 34 (one exemplary filter element 34 being depicted in FIG. 3 for simplicity). More specifically, the support plate 32 is suspended in the prefilter drum 22 such that the support plate 32 spans across and covers the width of the interior of the filter drum 22 to separate the drum 22 into an upper chamber 26 and lower chamber 28. As shown best in FIG. 4, the support plate 32 includes a plurality of spaced-apart apertures 36 for receiving corresponding filter elements 34. The number of spaced-apart apertures 36 and corresponding filter elements 34 may vary and is largely dependent on the size of the filter support plate 32 and corresponding width of the prefilter drum 22.

In preferred embodiments, the filter elements 34 are “filter socks” that are intended to be inserted into the spaced apart-apertures 36 such that the filter socks 34 extend downward into the lower chamber 28. For purposes of this disclosure, a “filter sock” shall be construed as an elongated mechanical filter made of a porous material (e.g., felt or mesh type material) that is intended to trap debris and particulates from the rainwater flowing through the filter assembly 30. In preferred embodiments, the filter socks 34 are designed to capture and retain particulates that are about 200 microns or larger such that the prefilter 20 is intended to remove larger debris and particulates without clogging. An example of a filter sock 34 is provided commercially by Aquatic Experts with a four-inch width and varying length options under the name “Aquatic Experts 4-inch 200 Micron Felt Filter Socks.”

According to certain embodiments, the filter socks 34 are removable from the filter assembly 30 such that the socks 34 may be cleaned or replaced as needed (the filter socks 34 are recommended to be cleaned or replaced at least once per year but the frequency may vary based on various factors including the amount of rainfall at the location of the harvesting system, the amount of debris associated with the particular harvesting system, the number of filter socks 34 being used in the prefilter 20, etc.). For example, and as depicted in the embodiment of FIG. 3, the filter socks 34 may be inserted into the apertures 36 and then held in place by a hold down plate 38 that is disposed on top of the support plate 32. As shown, the hold down plate 38 includes a plurality of apertures 39 that are positioned and configure to be aligned with the apertures 36 of the support plate 32. According to this embodiment, the filter socks 34 include a lip 35 that is sandwiched between the support plate 32 and hold down plate 38. Accordingly, the hold down plate 38 is used to apply pressure to hold or otherwise maintain the filter socks 34 in their appropriate apertures 36 of the support plate 32 during operation of the prefilter 20. The material/weight of the hold down plate 38 is selected to balance the need for sufficient downward pressure on the lip 35 of the filter socks 34 with respect to the support plate 32 while not putting too much downward pressure on the support plate 32 with respect to the drum 22. To remove the filter socks 34 from the filter assembly 30, the hold down plate 38 is operable to be lifted with respect to the support plate 32 or otherwise removed from the filter assembly 30 to access the filter socks 34.

According to other embodiments, the filter socks 34 themselves may include a weighted top lip 35 to assist in maintaining the filter socks 34 in their apertures during use without necessarily requiring the hold down plate 38. In yet another embodiment, the filter socks 34 may be removably secured directly to the apertures 36 of the support plate 32, such as by using a threaded or snap fit engagement between a top rim of the filter socks 34 and the corresponding apertures 36 of the support plate 32.

According to certain embodiments, the support plate 32 with corresponding filter socks 34 may be removed from the prefilter drum 22 as a single unit. For example, the support plate 32 may be removably secured/positioned within the interior of the prefilter drum 22. According to this embodiment, the filter socks 34 may also be removably secured to the support plate 32 as described above (i.e., when it is desired to have the filter socks be able to be both individually removed from the support plate and each removed as a unit with the support plate) or the filter socks 34 may be more permanently secured to the support plate 32 (i.e., when it is desired to allow for removal of the filter socks 34 only by removing as a unit). In embodiments in which the support plate 32 is fixedly secured to the interior surface of the prefilter drum 22, the support plate 32 may be sealed, fused, or welded (collectively referred to herein as “sealed”) directly to the interior side surface of the drum 22. For example, the sidewall of the drum 22 may include an inward protruding portion 23 disposed along its length as shown in FIG. 3. The support plate 32 then includes a diameter that corresponds to the inward protruding portion 23 such that the support plate 32 is configured to be sealed to the inward protruding portion 23 at the desired height for the support plate 32 within the filter drum 22. Similarly, the sidewall of the drum may include a tapered interior sidewall. The support plate 32 may then be configured to include a diameter corresponding to the desired position of the support plate 32 along the tapered sidewall. To position the support plate 32 within the drum 22, the support plate 32 would be lowered until the interior of the drum 22 includes a diameter small enough to prevent the support plate 32 from going any lower (for purposes of the present disclosure, the location of the taper in which the support plate is positioned during use may also be referred to as the “inward protruding portion 23” of the drum 22). The support plate 32 is then sealed at this position with respect to the tapered sidewall. According to embodiments in which the support plate 32 is fixedly secured to the interior of the prefilter drum 22, only the filter socks 34 are intended to be removable with respect to the filter assembly 30.

In embodiments in which the support plate 32 is removably inserted into the interior of the prefilter drum 22, the inward protruding portion 23 may be in the form of a flange that extends radially inward from the interior surface of the drum 22. The support plate 32 would then be supported by the flange. Appropriate engaging mechanisms may also be provided on the support plate 32 to engage with corresponding engaging mechanisms of the flange to removably connect the support plate 32 to the flange. Examples of engaging mechanisms include threads, male/female plugs, clamps, etc.

According to another aspect of the disclosure, and with reference to FIG. 4, the hold down plate 38 is removably connected to the support plate 32 with fasteners 50. In preferred embodiments, and as shown in FIG. 4, the hold down plate 38 includes a plurality of grooves 52 for receiving the fasteners 50. Each of the grooves 52 include a narrow portion and a wider portion. To secure the hold down plate 38 to the support plate 32, the fasteners 50 are screwed to the support plate 32 through the narrow portion of the grooves 52. To remove the hold down plate 38 from the support plate 32, the fasteners 50 are loosened and the hold down plate 38 is rotated such that the fasteners are positioned within the wider portion of the grooves 52. This allows a user to lift the hold down plate 38 from the filter assembly 30 to access the filter socks 34 while leaving the fasteners 50 connected to the support plate 32.

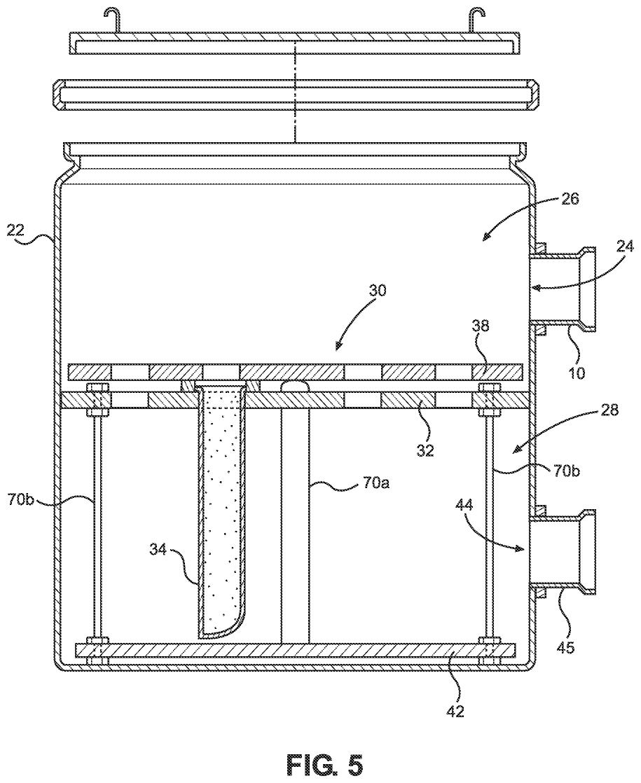

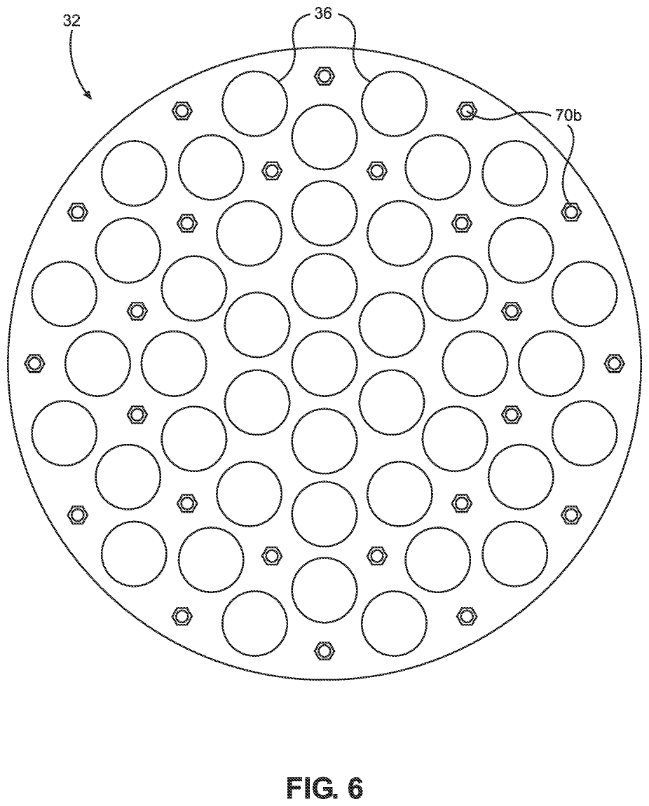

According to another aspect of the disclosure, and with reference to FIGS. 5-6, the filter assembly 30 in certain embodiments may further include one or more vertical supports 70a, 70b to help support the horizontal support plate 32 within the interior of the prefilter drum 22. As shown, the vertical supports 70a, 7b extend from a bottom plate 42 to the support plate 32. In certain embodiments, the filter assembly 30 includes a larger vertical support 70a connected to the middle of the support plate 32 with the filter socks 34 disposed around the vertical support 70a. Thinner vertical supports 70b could then be positioned as desired between filter socks 34 of the support plate 32. More specifically, the center support 70a may be a larger column type structure that is sealed to both the bottom plate 42 and the support plate 32. The rod supports 70b may then include threaded portions at their distal and proximal ends such that the rods may be connected to the bottom plate 42 and support plate 32 using threaded nuts. In certain embodiments, the support plate 32, vertical supports 70a, 70b, and bottom plate 42 together form a support structure that supports the filter socks 34 within the drum 22. It is noted that the vertical supports 70a, 70b could be provided in a wide range of constructions and configurations, and the vertical supports shown in FIGS. 5-6 are merely exemplary. The vertical supports are particularly useful for larger drums 22 having a support plate 32 intended to support a large number of filter socks 34 as represented by the support plate 32 depicted in FIG. 6.

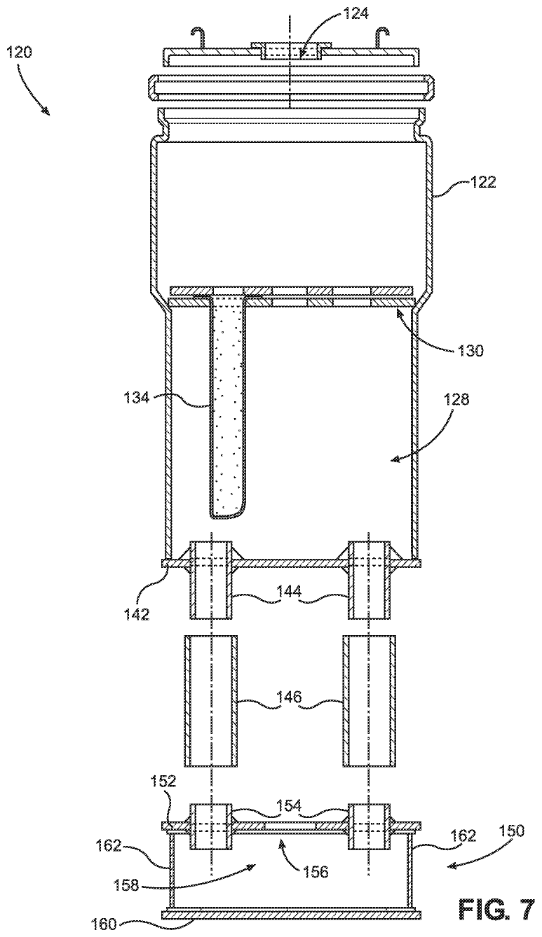

According to another embodiment of the disclosure, and with reference to FIG. 7, a prefilter system 120 includes a prefilter drum 122 that is intended to be supported within a cistern tank (not shown). According to this embodiment, the prefilter drum 122 further includes a bottom plate 142 having a plurality of outlet nozzles 144. In certain embodiments, the bottom plate 142 may be the actual bottom of the prefilter drum 122 with apertures formed therein for inserting the nozzles 144. However, in other embodiments, the bottom surface of a commercially available prefilter drum 122 is removed and replaced with a bottom plate 142 having nozzles 144 formed into the bottom plate 142. The outlet nozzles 144 remove filtered rainwater from the lower chamber 128 of the prefilter drum 122 similar to the fluid outlet 44 of the system of FIGS. 3 and 5. However, in this embodiment, the outlet nozzles 144 are fluidly connected to a calming inlet assembly 150 that is positioned at the bottom of the cistern tank using pipes 146 having an appropriate length. Thus, the prefilter drum 122 is supported within the cistern tank by the drum's connection to the calming inlet assembly 150.

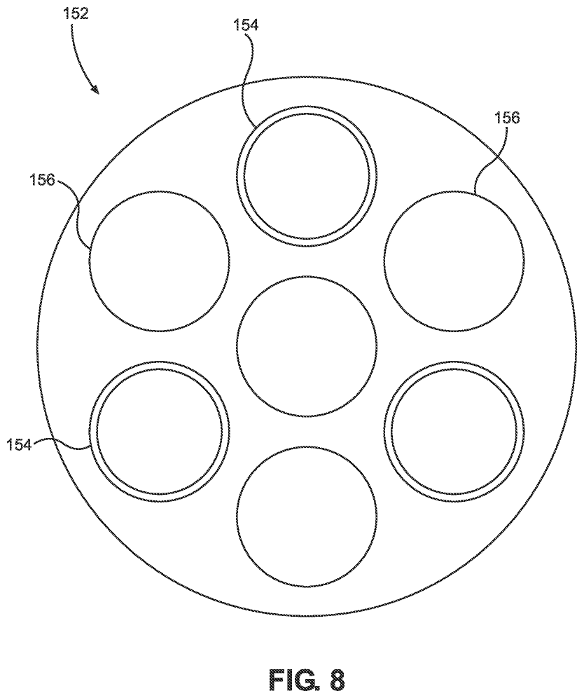

In certain embodiments, and with continued reference to FIG. 7, the calming inlet assembly 150 includes a top plate 152 having inlet nozzles 154 that are fluidly connected to corresponding outlet nozzles 142 of the prefilter drum 122. As noted above, and as shown in FIG. 7, pipes 146 may be provided to fluidly connect outlet nozzles 144 of the prefilter drum 122 to the inlet nozzles 154 of the calming inlet assembly 150. In other embodiments, the outlet nozzles 144 may be connected directly to the inlet nozzles 154. However, pipes 146 are preferably used such that the desired position of the prefilter drum 122 within the cistern tank may be easily obtained by selecting pipes 146 with an appropriate length needed to position the calming inlet assembly 150 at the bottom of the cistern tank. With reference to FIGS. 7 and 8, the top plate 152 of the calming inlet assembly 150 further includes one or more outlet ports 156. In operation, collected rainwater flows into the prefilter drum 122 through fluid inlet 124. The rainwater then flows through the filter socks 134 of the filter assembly 130. The filtered rainwater then flows through the outlet nozzles 144 of the prefilter drum 122 and through the inlet nozzles 154 of the calming inlet assembly 150 into a calming inlet collection chamber 158. When the calming inlet collection chamber is full, filtered rainwater exits through outlet ports 156 of the calming inlet assembly 150 and into the cistern tank.

According to another aspect of the disclosure, prefilter 20 and 120 may be assembled relatively inexpensively with aftermarket parts substantially as described below. It should be understood that the parts described below are exemplary and particular parts could be substituted with similar parts having similar properties and functions. Dimensions may change and/or scaled as desired but the below are provided as generally preferred dimensions that have been found to provide an efficient prefilter that allows for a large passage of rainwater during high flow rates without being overrun.

As a first step, an appropriate prefilter drum is selected based on the demands of the rainwater harvesting system in which the prefilter is intended to be used. In preferred embodiments, the prefilter drum ranges from about 14 to 165 gallons. Preferred dimensions include a height of about 22 inches to about 36 inches and a diameter that ranges between about 15 inches to about 36 inches. The support plate of this embodiment would be positioned at preferably about fourteen to about fifteen inches above the bottom of the filter drum. One example of a filter drum is provided commercially under the name McMaster Carr Model No. 4319T27, which is a 15-gallon drum made from high density polyethylene plastic (HDPE). As somewhat exemplified in FIG. 3, it includes a drum top 19 that is closable using a drum clamp 21. An opening is provided in either the drum top 19 (as depicted in FIG. 1) or through an upper portion of the sidewall of the prefilter drum 22 (as depicted in FIG. 3) to provide the fluid inlet 24 depending on the orientation of the fluid entrance pipe 10 (see FIG. 1 depicting the fluid inlet 24 in the drum top 21 and FIG. 2 depicting the fluid inlet 24 in the sidewall of the prefilter drum 22). Entrance pipe 10 typically has a diameter in the range of about 4 inches to about 12 inches. Seals or gaskets may be placed at the fluid inlet 24 (and the fluid outlet 44) to receive the entrance pipe 10 (and the outlet pipe 45) to prevent leaks within the fluid connection of the prefilter 20 to the rest of the rainwater harvesting system. An example pipe seal for a 4-inch entrance pipe 10 or outlet pipe 45 is available commercially as the 4″ Multi-Tite Rubber Grommet Seal available from Septic Solutions.

To create the filter assembly 30, a filter element support plate 32 is selected to have a diameter that is slightly smaller than the interior diameter of the upper chamber 26 at the location in which the support plate 32 is intended to be positioned. An exemplary filter element support plate 32 for the McMaster fifteen-gallon prefilter drum 22 is a HDPE sheet that is about ¼″ inches thick and includes a diameter of about 16.875 inches. With reference to FIG. 3, a plurality of apertures 36 are provided in the support plate 32 for receiving the filter socks 34. Similarly, in embodiments with a hold down plate 38 as described above, a similar HDPE sheet may be provided with the same number of apertures 39 corresponding to the apertures 36 of the support plate 32. When the hold down plate 38 is positioned over the support plate 32 to provide weight to the filter socks 34 for assisting in maintaining the position of the filter socks 34 in their corresponding apertures 36, the apertures 49 of the hold down plate 38 are preferably positioned and configured to be vertically aligned with the apertures 36 of the support plate 32 such that collected rainwater is able to easily flow through the aligned apertures to the filter socks 34 of the support plate 32.

In continuing to retrofit the prefilter drum 22, the prefilter drum is modified to include one or more fluid outlets 44. With reference to FIGS. 1-3 and 5, the fluid outlet 44 is formed into the sidewall of the drum 22. In other embodiments, the fluid outlet 44 is formed directly into to the bottom surface of the drum 22. In further embodiments, and with reference to FIG. 7, the bottom of the commercially available drum 122 is removed and replaced with the bottom plate 142. The bottom plate is sealed to the bottom of the prefilter drum 122. The bottom plate 142 is preferably a HDPE sheet as described above with respect to the support plate 32. However, the bottom plate 142 may be formed of many different materials as known in the art. The bottom plate 122 is modified to include a plurality of apertures with outlet nozzles 144 then sealed in the apertures. Preferred outlet nozzles 144 include a diameter of about three inches to about 12 inches depending on the size of the prefilter drum 122. Exemplary outlet nozzles 144 are provided commercially under the name PolyPipe® by Dura-Line.

With reference to FIG. 7, the calming inlet assembly 150 is formed using a top plate 152, bottom plate 160, and sidewalls 162 to connect the top plate to the bottom plate for forming the calming inlet collection chamber 158. With reference to FIG. 8, the top plate 152 includes a first set of apertures for receiving inlet nozzles 154. The top plate further includes a second set of apertures that form the outlet ports 156. In certain embodiments, the top plate 152 and bottom plate 160 of the calming inlet assembly 150 are formed using an HDPE sheet as described above. The calming inlet assembly 150 is then formed by joining the top plate 152 to the bottom plate 160 using an HDPE pipe with a larger diameter such that the pipe forms the sidewalls 162. For example, in certain embodiments, the top plate 152 and bottom plate 160 include a thirteen-inch diameter. A four-inch length of pipe having a twelve-inch diameter is then sealed at one end to the top plate 152 and at the opposite end to the bottom plate 160 to form the calming inlet assembly 150.

The foregoing description of preferred embodiments for this disclosure have been presented for purposes of illustration and description. They are not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A rainwater harvesting prefilter, the prefilter comprising:
a filter drum including a fluid inlet configured to be fluidly connected to a fluid entrance pipe of a rainwater collection system and a fluid outlet configured to be fluidly connected to a cistern tank; and
a filter assembly disposed in the filter drum, the filter assembly including:
a filter support plate suspended in the filter drum such that the filter support plate spans across and substantially covers a width of the filter drum to separate the filter drum into an upper chamber having the fluid inlet and a lower chamber having the fluid outlet,
a plurality of spaced-apart apertures disposed in the filter support plate, and
a plurality of filter socks for filtering rainwater as it flows through the fluid inlet to the fluid outlet, each of the plurality of filter socks positionable in one of the plurality of spaced apart apertures such that filter sock extends downward from the filter support plate into the lower chamber.

2. The rainwater harvesting prefilter of claim 1 wherein the filter support plate is sealed to an interior sidewall of the filter drum.

3. The rainwater harvesting prefilter of claim 2 wherein the filter drum includes an interior sidewall having an inward protruding portion and the filter support plate is sealed to the inward protruding portion.

4. The rainwater harvesting prefilter of claim 1 wherein the plurality of filter socks are configured to be removably inserted into the spaced-apart apertures of the filter support plate.

5. The rainwater harvesting prefilter of claim 1 wherein the plurality of filter socks are configured to retain particulates that are about 200 microns or larger.

6. The rainwater harvesting prefilter of claim 1 wherein the filter assembly further includes a hold down plate configured to be positioned over the filter support plate to assist in maintaining the plurality of filter socks in the plurality of spaced apart apertures.

7. The rainwater harvesting prefilter of claim 6 wherein the hold down plate includes a plurality of spaced-apart apertures positioned and configured to be vertically aligned with the plurality of spaced-apart apertures of the filter support plate when the hold down plate is positioned over the filter support plate.

8. The rainwater harvesting prefilter of claim 7 wherein each of the plurality of filter socks include a lip extending radially from a top end of the filter sock such that the lip is disposed between the hold down plate and the filter support plate when the hold down plate is positioned over the filter support plate.

9. The rainwater harvesting prefilter of claim 7 wherein the hold down plate includes a plurality of grooves for receiving fasteners, the grooves including a narrow portion for removably fastening the hold down plate to the filter support plate when the fasteners are tightened and a wider portion for removing the hold down plate from the filter support plate when the fasteners are loosened.

10. The rainwater harvesting prefilter of claim 1 wherein the fluid outlet includes a plurality of outlet nozzles.

11. The rainwater harvesting prefilter of claim 10 further comprising a calming inlet assembly, the calming inlet assembly including a plurality of inlet nozzles each fluidly connected to one of the plurality of outlet nozzles of the filter drum.

12. The rainwater harvesting prefilter of claim 1 wherein the filter assembly further includes one or more vertical supports, the vertical supports extending from a bottom plate positioned adjacent a bottom of the filter drum to the filter support plate.

13. A method of forming a rainwater harvesting prefilter, the method comprising:
selecting a prefilter drum having a volume that ranges from about 14 gallons to about 165 gallons;
forming a fluid inlet and a fluid outlet in the prefilter drum;
providing a filter support plate having a plurality of spaced-apart apertures;
sealing the filter support plate to an interior sidewall of the filter drum such that the filter support plate spans across and substantially covers a width of the filter drum to separate the filter drum into an upper chamber having the fluid inlet and a lower chamber having the fluid outlet; and
positioning filter socks in each of the plurality of spaced apart-apertures such that the filter socks extend downward from the filter support plate into the lower chamber, the filter socks for filtering rainwater as it flows through the fluid inlet to the fluid outlet.

14. The method of claim 13 wherein the interior sidewall of the filter drum includes an inward protruding portion and the filter support plate is sealed to the inward protruding portion.

15. The method of claim 13 wherein the filter socks are configured to retain particulates that are about 200 microns or larger.

16. The method of claim 13 further comprising positioning a hold down plate over the filter support plate to assist in maintaining the filter socks in the plurality of spaced apart apertures.

17. The method of claim 16 wherein the hold down plate includes a plurality of spaced-apart apertures positioned and configured to be vertically aligned with the plurality of spaced-apart apertures of the filter support plate when the hold down plate is positioned over the filter support plate.

18. The method of claim 17 wherein the hold down plate includes a plurality of grooves for receiving fasteners, the grooves including a narrow portion for removably fastening the hold down plate to the filter support plate when the fasteners are tightened and a wider portion for removing the hold down plate from the filter support plate when the fasteners are loosened.

19. The method of claim 13 further comprising securing a distal end of one or more vertical supports to a bottom plate, positioning the bottom plate with one or more vertical supports adjacent a bottom of the filter drum, and securing a proximal end of the one or more vertical supports to the filter support plate to form a support structure for the filter support plate.
